(19) United States
(12) Patent Application Publication
(10) Pub. No.: US 2014/0238124 A1
(43) Pub. Date: Aug. 28, 2014

(54) FLOWMETER FOR TWO-PHASE GAS/LIQUID CRYOGENIC FLUIDS

(71) Applicants: Antony Dallais, Janvry (FR); Thierry Dubreuil, Boissets (FR); Didier Pathier, Voisins Le Bretonneux (FR); Mohammed Youbi-Idrissi, Massy (FR)

(72) Inventors: Antony Dallais, Janvry (FR); Thierry Dubreuil, Boissets (FR); Didier Pathier, Voisins Le Bretonneux (FR); Mohammed Youbi-Idrissi, Massy (FR)

(73) Assignee: L'Air Liquide Societe Anonyme Pour L'Etude Et L'Exploitation Des Procedes Georges Claude, Paris (FR)

(21) Appl. No.: 14/122,137

(22) PCT Filed: May 15, 2012
(86) PCT No.: PCT/FR2012/051083

§ 371 Date: Nov. 25, 2013

(30) Foreign Application Priority Data
May 25, 2011 (FR) 1154550

(51) Int. Cl. G01F 1/00

(52) U.S. Cl. CPC G01F 1/00
USPC 73/200

(57) ABSTRACT

The invention relates to a flowmeter for two-phase gas/liquid cryogenic fluids, comprising: a liquid/gas phase separator, preferably consisting of a tank, into the top part of which the cryogenic liquid is admitted; a liquid flow-rate sensor, located in a liquid duct in fluid communication with the bottom part of the tank, the tank being placed in a high position in space relative to the liquid flow-rate sensor; a gas duct, in fluid communication with the top part of the tank equipped with the gas valve; and a device for measuring the level of liquid in the tank, preferably comprising two level sensors: a lower level sensor and an upper level sensor.

The present invention concerns the field of flowmeters for two-phase gas/liquid fluids.

Measuring the flow rate of a two-phase fluid composed of a liquid and a gas is a difficult operation when it is sought to measure a mass flow rate. This is because all sensors measuring a flow rate are disturbed when they are put in contact with a two-phase liquid the density of which changes continuously. This is in particular valid for measuring the flow rate of cryogenic fluids such as liquid nitrogen.

On the instrumentation market there are various flow-rate measuring systems. Some of these flowmeters are based on a measurement of the speed of the fluid. They are for example:
so-called “turbine” flowmeters: a turbine is installed in the moving fluid and the rotation speed of the turbine gives an image of the speed of the fluid;
so-called “pitot tube” flowmeters: two tubes are installed in the moving fluid to be measured. One tube is installed perpendicular to the flow rate and gives a static pressure while the other is installed parallel to the flow rate and gives a total dynamic pressure. The difference in dynamic pressure between these two measurements makes it possible to calculate the flow rate;
so-called “ultrasound” flowmeters: some use the Doppler effect (analysis of the frequency reflected by the particles of the fluid, which gives an image of the speed of the particle and therefore of the fluid) while others measure a difference in travel time of an ultrasound wave from upstream to downstream and from downstream to upstream (image of the speed of the fluid).

In all cases, when the density of the fluid varies continually, the change from volume flow rate to mass flow rate is tricky to determine precisely.

Other systems that use a measurement of pressure drop to deduce the flow rate are also found on the market. These are for example calibrated-orifice flowmeters that measure the pressure drop upstream and downstream of a calibrated orifice placed in the moving fluid. The measurement of these appliances is greatly disturbed when the fluid does not have a constant density and when the level of gas increases in the liquid.

So-called “electromagnetic” flowmeters are also found on the market, which are applicable only to fluids having sufficient electrical conductivity since they use the principle of electromagnetic induction: an electromagnetic field is applied to the fluid and the electromotive force created (the force proportional to the flow rate of the fluid) is measured. In the case of the measurement of flow rates of cryogenic (non-conductive) fluids such as liquid nitrogen, this principle is not applicable.

Vortex-effect flowmeters for their part are based on the phenomenon of the generation of vortices that are found between a non-profiled fixed body placed in a moving fluid (Karman effect). Measuring the variations in pressure created by these vortices gives the frequency of the vortices, this being proportional to the speed of the fluid when the fluid keeps constant properties. When the density of the fluid varies, here again the measurement will be falsified.

Thermal flowmeters can also be cited, which for their part are based on the measurement of the increase in temperature created by a constant addition of energy. A system with two temperature sensors measures the difference in temperature between the incoming and outgoing flow rates of the flowmeter. Between these two sensors, a resistor provides a known quantity of energy. When the heat capacity of the moving fluid is known, the flow rate can be calculated from these measurements. However, this principle is not applicable to two-phase liquids, the thermal behaviour (vaporisation of the liquid) of which is completely different from single-phase liquids.

Only the Coriolis-effect mass flowmeter gives a more precise measurement of the mass flow rate of a fluid. The flowmeter consists of a tube in the shape of a U or omega or curve, in which the fluid flows. The U is subjected to a lateral oscillation and the measurement of the phase difference in the vibrations between the two arms of the U gives an image of the mass flow rate. However, its cost is fairly high and, when it is used at very low temperatures (liquid nitrogen at −196° C. for example) and with a fluid the density of which varies enormously and comprises a significant proportion in the gaseous phase, there is a need to greatly insulate the system (a high-performance insulation is required, such as insulation under vacuum for example) and, despite these precautions, the measurements are sometimes falsified.

As can be found from reading the above, measuring the flow rate of a two-phase liquid and in particular measuring the flow rate of a cryogenic fluid such as liquid nitrogen, with a precision of at least 3% as is normally required in industry, is not easy to achieve with the systems currently available on the market.

The literature has therefore proposed other types of solution, including systems based on the principle of measuring the level of a liquid flowing in a channel just before a restriction of the cross section of flow. This system, described in the document U.S. Pat. No. 5,679,905, functions in substance as follows: the two-phase fluid is first of all separated into a gaseous phase that is not measured and a liquid phase the flow rate of which is measured. This liquid passes through a channel that has a reduction in cross section at its outlet. The greater the flow, the higher the level of liquid in the channel, and measuring the level in this channel makes it possible to derive the instantaneous flow rate. As is found, this system does not take into account the gas flow rate, which in some applications is negligible. On the other hand, this system makes it possible to measure the liquid flow rate with relatively good precision without being disturbed by the level of gas, which is the aim sought.

It will be noted in passing that, for this system to function correctly, it must be well insulated from ingresses of heat that could vaporise part of the insulated liquid and thus interfere with the level measurement. Thus insulation under vacuum is used in this system.

It should also be noted that, for the system to function, there must be the presence of two phases in the flowmeter, which prevents its functioning with a sub-cooled liquid (neat liquid without gaseous phase).

In the case where measuring the flow rates of liquid and gas is necessary, a system is sometimes used that repeats the same principle of separation of the phases before measuring flow rate.

Thus appliances having the following device have been proposed in the literature and marketed:
The two-phase liquid passes first through a phase separator that separates the liquid phase and gaseous phase.
The gaseous phase is directed to a volume flowmeter (turbine type for example) with temperature compensation.
The liquid phase is also directed to a volume flowmeter (turbine type for example).
These two flow-rate measurements are then converted into a mass measurement and added.

In principle this device is more expensive that the previous one and it may be thought that it will be very precise. In practice, it is found that the measurement of the liquid flow rate is marred by errors that fluctuate according to the pressure and temperature conditions of the liquid entering the flowmeter. These measurement errors are due to the presence of gas in liquid phase passing through the flowmeter. This is because, when the liquid leaves the phase separator in order to go to the flowmeter, some of the liquid vaporises either because of ingresses of heat or because of the pressure drop due to a rising of the liquid or because of a pressure drop due to the loss of pressure created by the flowmeter itself.

Finally, in order to measure the flow rate of a cryogenic liquid, the problems cited above can also be dispensed with by creating pressure and temperature conditions different from the equilibrium pressure (the boiling limit). In this field, the method normally used is increasing the pressure of the liquid. In practice, a flowmeter will for example be installed at the outlet of a cryogenic pump (high-pressure side). In this case, the liquid is for example pumped into a tank where it is at equilibrium and its pressure is increased by the pump almost without increase in temperature. The pipework and flowmeter that follow may then create a pressure drop; this will not result in vaporising the liquid provided that the pressure drop is appreciably less than the increase in pressure created by the pump.

In this case, a conventional flowmeter of the vortex, turbine or other type can be used, provided that it withstands low temperatures.

This technique is perfectly suited to measuring the flow rate of nitrogen-delivery lorries for example. It is reliable and has an acceptable cost since the cryogenic pump is required for other reasons.

On the other hand, when it is necessary to measure the flow rate of liquid nitrogen at a point where there is no cryogenic pump, then this technique is no longer applicable in practice.

The present invention therefore seeks to propose a simple and reliable novel solution for measuring the flow rate of two-phase gas/cryogenic liquid fluids, solving all or some of the technical problems mentioned above.

As will be seen in greater detail below the solution proposed here may be summarised thus:
The fluid may arrive at a pressure that is variable but generally low (typically between 1 and 6 bar), and under pressure and temperature conditions that are in principle unknown. In particular, the liquid phase may be at equilibrium (saturation).
The fluid may be composed of a liquid phase and a gaseous phase (two-phase liquid).
No device for increasing the pressure (pump) is required (or available) on the installation.
The measuring device according to the invention can be positioned in line, on the supply duct of a cryogenic apparatus consuming the cryogenic liquid, such as a cryogenic tunnel, a churner, etc.

The device proposed comprises the following elements:
A tank fulfilling the role of phase separator installed in a high position in the installation (typically in the preferred range between 1 and 6 metres) relative to a liquid-phase flow-rate sensor position on the duct conveying this liquid phase to equipment downstream from the flow-rate measurement device (such as a tunnel as stated above).
It would of course be possible to use, instead of a tank, any other device for separating the liquid phase and the gaseous phase from the initial fluid (for example a tube provided with baffles, or a tube comprising a porous material).
This tank is equipped, according to a preferred embodiment, with two level sensors: a lower level sensor and an upper level sensor. As an alternative to these two level sensors, it is also possible to use according to the invention any level measurement technique that will give the measurement of the liquid level in the tank (and in particular for example a measurement of pressure difference between the top and bottom of the tank, or a rod immersed in the cryogenic liquid and connected to a capacitance measurement, or a measurement by ultrasound of the difference between the top of the tank and the surface of the liquid, etc.). In this case, this level management will be coupled to low and high thresholds. This level measurement device will be sized according to the range of the liquid flow rate that is to supply the equipment downstream.
A liquid-phase flow-rate sensor situated lower (in height) and downstream with respect to the phase separator. This flowmeter may be of the turbine or vortex-effect type or any other technology.
Advantageously, a gas-phase flow-rate sensor is present with which a temperature sensor and a pressure sensor can be associated, the gas phase coming from the top part of the tank (or other phase separator). This flowmeter may be of the turbine or vortex-effect type or be any other technology. For more precision, the measurement can be compensated for temperature and pressure.
A gas valve situated downstream or upstream of the gas-phase flow-rate sensor mentioned above when the latter is present (according to circumstances, according to the characteristics of the gas flowmeter when present, the gas valve may be situated upstream or downstream of this sensor).
Advantageously a liquid valve is present, situated downstream or upstream of the liquid flowmeter situated on the duct bringing this liquid phase to downstream equipment (here again, according to circumstances, according to the characteristics of the liquid flowmeter, the liquid valve when present may be situated upstream or downstream of the flowmeter). This liquid valve is closed when the liquid level in the phase-separator tank is below a minimum lower limit. The discharge of fluid passing through the liquid flowmeter will therefore be prevented when the flowmeter is not under load with neat liquid, without gas.
A measurement of gaseous phase by the liquid flowmeter is therefore excluded by virtue of this provision.
In order to avoid abrupt closure of this valve, its closure will preferentially be effected gradually on approaching the low level (the level of liquid in the tank approaching the lower limit).
During the closure of the liquid valve, the gas valve remains open. The information on closure of this valve corresponding to a diagnosis of a defect in liquid-nitrogen supply in the system, this information may advantageously be used by the user in order to assess the situation and where necessary remedy this supply defect.
The gas valve downstream (or upstream) of the gas flowmeter is closed when the liquid level in the phase separator is above the level of the upper limit. Discharge of the liquid phase through the gas flowmeter will therefore be prevented and an erroneous measurement of the liquid phase by the gas flowmeter is therefore excluded by virtue of this provision. In order to prevent abrupt closure of this gas valve, closure of the gas valve is preferentially performed gradually on approaching the high level (liquid level in the tank approaching the high limit). During the closure of the gas valve, the liquid valve remains open.
The assembly is thermally insulated.

The present invention therefore concerns a flowmeter for two-phase liquid/gas cryogenic fluids, comprising:
a liquid/gas phase separator, preferentially a tank, in the top part of which the cryogenic liquid is admitted;
a liquid flow-rate sensor, situated on a liquid duct in fluid communication with the bottom part of the tank, the tank being placed in a high position in space relative to the liquid flow-rate sensor;
a gas duct, in fluid communication with the top part of the tank, provided with a gas valve;
a device for measuring the liquid level in the tank, preferentially comprising two level sensors: a lower level sensor and an upper level sensor.

The flowmeter according to the invention can moreover adopt one or more of the following features:
the flowmeter also comprises:
   a liquid valve, upstream or downstream of the liquid flowmeter on said liquid duct;
   a sensor for the flow rate of the gas phase issuing from the top part of the tank, situated on said gas duct upstream or downstream of said gas valve;
a vertical or substantially vertical tube connects the bottom part of the separator (tank) to said liquid duct provided with the liquid flow-rate sensor, representing the height of the separator in space, and the flowmeter comprises, around all or part of the length of said vertical tube, a concentric tube, forming between the vertical tube and concentric tube a concentric cavity able to receive liquid coming from the separator (tank), while the evaporation gases from this cavity are able to be sent to the top part of the separator;
all or part of the height of the concentric cavity is provided with baffles.

The invention also concerns a method for measuring the flow rate of two-phase liquid/gas cryogenic fluids, using a flowmeter in accordance with the invention.

Other features and advantages of the present invention will emerge more clearly from the following description, given by way of illustration but in no way limitatively, made in relation to the accompanying drawings, for which:

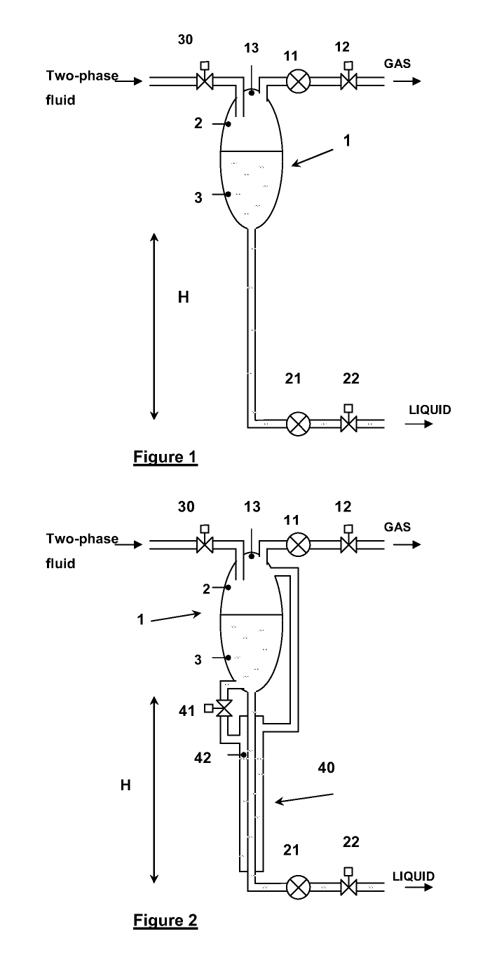

FIG. 1 is a partial schematic view of an embodiment of a device for measuring flow rates of two-phase fluids according to the invention.

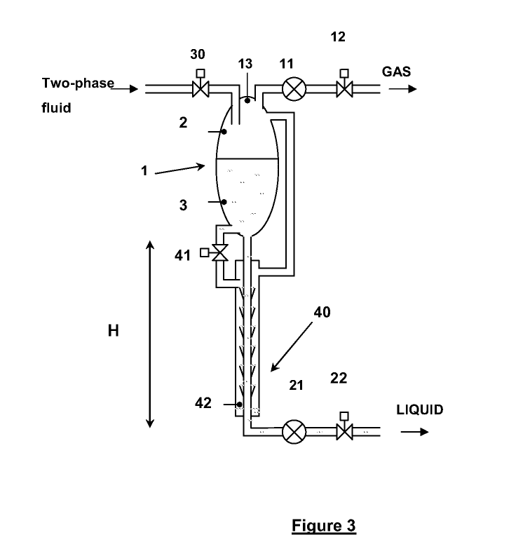

FIG. 2 is a partial schematic view of another embodiment of a device for measuring flow rates of two-phase fluids according to the invention.

FIG. 3 is a partial schematic view of a third embodiment of a device for measuring flow rates of two-phase fluids according to the invention.

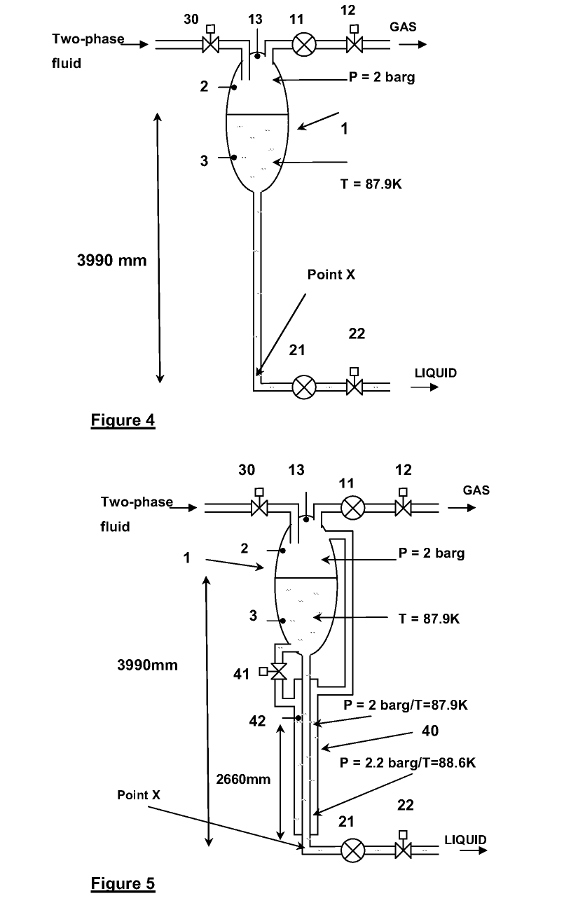

FIGS. 4 to 6 show comparisons of behaviour of three devices of FIGS. 1, 2 and 3.

The following elements can be recognised in FIG. 1:
the two-phase fluid, for example liquid nitrogen, arrives and is admitted in the top part of the tank 1, fulfilling the role of phase separator (as indicated above, other embodiments of phase separators other than a tank could be used): the tank is installed in a high position (height H: typically between 1 and 6 metres) in the installation relative to a liquid-phase flow-rate sensor 21, the sensor 21 positioned on a duct bringing this liquid phase to downstream equipment;
the presence or a vertical (or substantially vertical) tube, descending in space, and connecting the bottom part of the tank to the duct bringing the liquid phase to a downstream item of equipment, can then be seen;
the tank 1 is here equipped with two level sensors: a lower level sensor 3 and an upper level sensor 2. As indicated above, as a variant to these two level sensors, it is also possible to use a level measurement device that would give the measurement of the liquid level in the tank;
the flow rate sensor 21 (flowmeter) for the liquid phase may be of the turbine type, vortex effect or any other technology;
according to an advantageous embodiment of the invention, a liquid valve 22 is present, here downstream of the liquid flowmeter 21, on the duct bringing this liquid phase to a downstream item of equipment (according to the type of liquid flowmeter 21 chosen, the liquid valve 22 could also be positioned upstream of this flowmeter 21);
a gas valve 12, situated on a duct in fluid communication with the top part of the tank (or other phase separator).
According to an advantageous embodiment of the invention, a flow rate sensor 11 for the gas phase (comprising where applicable a temperature probe and a pressure probe) is also present, situated here upstream of the valve 12 (as already stated, according to the technology of the flowmeter 11 adopted, the valve 12 can also be positioned upstream of the flowmeter). This flowmeter could be of the turbine type, vortex effect or any other technology. For more precision, the measurement could be compensated for temperature and pressure.
According to one embodiment of the invention, the liquid valve 22 is automatically closed when the level of liquid in the phase separator is below a minimum lower limit (sensor 3). Discharge of the fluid passing through the liquid flowmeter 21 would therefore be prevented when the flowmeter is no longer charged with neat liquid, without gas.

In a preferred fashion, in order to prevent abrupt closure of this valve 22, the closure thereof will preferentially be performed by an automatic controller gradually on approaching the lower level (the liquid level in the tank approaching the lower limit giving rise to a gradual closure).

During the closure of the liquid valve 22, the gas valve 12 remains open. The information on closure of this valve corresponding to a diagnosis of a defect in supply of liquid nitrogen to the system, this information can advantageously be used by the user to study the situation and where applicable intervene in order to remedy this defect in supply.
According to one embodiment of the invention, the gas valve 12 downstream of the gas flowmeter 11 is automatically closed when the liquid level in the phase separator is above the level of the upper limit (sensor 2). The discharge of the liquid phase by the gas flowmeter will therefore be prevented and an erroneous measurement of the liquid phase by the gas flowmeter is therefore excluded. In a preferred manner, in order to prevent abrupt closure of this gas valve 12, the closure of the gas valve is preferentially performed by an automatic controller gradually on approaching the upper level (liquid level in the tank approaching the upper level giving rise to a gradual closure). During the closure of the gas valve 12, the liquid valve 22 remains open.

It should be noted that the gas phase extracted via the assembly 11/12 may be recovered in order to be directed to a station using such a gaseous phase on the site.

FIG. 1 moreover illustrates the optional presence of a valve 30 on the duct bringing the two-phase fluid to the tank 1, a presence that is optional but advantageous when it is useful to control the pressure of fluid discharged from the flowmeter (and therefore supplying the downstream station): the valve 30 is added to the installation at the inlet of the separator 1, associated with a pressure sensor 13 installed in the top part of the phase separator, and this valve 30 will be automatically closed when the pressure is below the set value and open in the other cases.

As indicated above, all or part of the device is insulated, in that all the tubes and tanks containing the cryogen in its liquid form must be insulated in order to prevent vaporising it. The insulation may be of many types, more or less expensive (foam, rockwool, vacuum insulation or other), bearing in mind that, if the system is insufficiently insulated, it will consume cryogen unnecessarily, even if a precise measurement is nevertheless obtained.

And, in the particular case of the vertical tube starting from the tank in order to join the liquid flowmeter, a tube representing the height of the tank in the installation, this vertical tube will be correctly insulated, preferentially under vacuum, in order to preserve the sub-cooling effect sought according to the invention by the height of the tube.

As will be seen below, if the descending tube is insufficiently insulated, it is possible to propose an improvement to this insulation by installing a concentric tube forming a cryogenisable cavity around the descending tube, as proposed in the context of FIGS. 2 and 3 below.

FIG. 2 illustrates in fact another embodiment of a device according to the invention, the elements identical to those present in the embodiments in FIG. 1 bear the same reference.

This embodiment of FIG. 2 then differs through the presence of a concentric tube 40 around the vertical tube starting from the tank in order to join the liquid flowmeter, or at least around a large portion of this verticality.

This option of the presence of the concentric tube is particularly advantageous when the device must measure precisely an intermittent flow rate, the tube descending from the phase separator as far as the liquid flowmeter is then, by virtue of this provision that will now be detailed, kept cold.

These intermittent flows (low flow or no flow for a given time) pose special technical difficulties since even a very small ingress of heat may vaporise the nitrogen situated in the descending central tube (since the nitrogen flows little or not all at certain moments and this small ingress of heat is not distributed over a large flow of circulating nitrogen).

More precisely, as clearly illustrated in FIG. 2, between the descending tube of the phase separator as far as the liquid flowmeter and the second concentric tube 40 a concentric cavity is naturally provided, which is filled with liquid coming from the tank 1, while the evaporation gases in this cavity are returned to the tank 1 (a tube connects the top of the cavity to the gas phase of the separator 1), and there is therefore obviously no overall fluid loss, the flow of nitrogen taken off to supply the tube interspace vaporises and is counted as a flow of gaseous nitrogen by the sensor 11.

The cavity is equipped with a level sensor 42 that controls the opening of a liquid-fluid supply valve 41, making it possible to maintain a substantially constant level of liquid in this cavity by returning the evaporation gases to the phase separator.

This arrangement makes it possible to keep sub-cooled the liquid the flow rate of which is to be measured in the liquid state: the role of the concentric tube being to create a zone at lower pressure and therefore at a lower temperature in order to prevent the liquid at the centre heating up. In this case, in the double jacket created by the two concentric tubes, the pressure is below the pressure prevailing in the central tube and the external temperature is therefore slightly less than the internal temperature. And, because of the liquid height pressure in the double jacket, the temperature at the bottom of the double jacket is slightly higher at the bottom than at the top.

In other words, by virtue of this concentric arrangement, when there are ingresses of heat (and there are always ingresses of heat), they arrive from outside and vaporise the nitrogen contained between the two concentric tubes. Consequently the nitrogen circulating in the descending central tube for its part does not experience this ingress of heat; it is the “external” nitrogen that absorbs these ingresses of heat and allows nothing to pass to the inside. It can therefore be said that the ingresses of heat in the central tube are zero. There is therefore no heating of the fluid that descends in the central tube.

FIG. 3 illustrates another embodiment of a device according to the invention, the elements identical to those present in the embodiment of FIG. 2 baring the same reference.

This embodiment in FIG. 3 therefore differs in that it has been sought to further improve the cold-maintenance system afforded by the concentric tube in FIG. 2, to prevent the external liquid for keeping the central tube cold heating up under the effect of the tube-height pressure. To do this, as illustrated in FIG. 3, the space in the cavity (between the two concentric tubes) has been fitted out by means of baffles. Only the first baffle (the highest) is supplied with liquid; when it overflows the second baffle fills, etc., until the last baffle, which will then overflow into the bottom of the cavity.

The bottom of the cavity is equipped with a level probe 42, which controls the valve 41 supplying the first baffle.

This embodiment in FIG. 3 then further somewhat improves the embodiment in FIG. 2 by reducing the pressure at the bottom of the double jacket; the pressure of the liquid is everywhere the same and the temperature is kept very low even at the bottom of the system.

The experiments carried out by the applicant showed that, by means of one or other of these embodiments:
a very precise measurement of the gas phase passing through the flowmeter is obtained, the measurement never being disturbed by an ingress of liquid, even when the flowmeter is supplied with sub-cooled liquid;
moreover, for measuring the liquid flow rate, having the phase separator much higher than the liquid flow rate sensor 21 in the space eliminates the “flash” phenomenon in the pipework between the phase separator and the liquid flow rate sensor 21 as well as in the sensor itself.

This flash phenomenon corresponds to a rapid vaporisation of part of a fluid at boiling equilibrium at the moment when its pressure drops. Installing the phase separator fairly high creates a pressure related to the height of liquid under load in the pipework. However, it is perceived in practice that, the pressure drops due to the pipework and to the flow rate sensor 21 often being less than 0.1 bar, a height of liquid of approximately 1 to 1.20 m for the liquid nitrogen for example will be sufficient to compensate for them.

For safety, it is even possible to increase the charge height in order to guarantee the absence of any flash phenomenon. In this way in fact a sub-cooled liquid would be obtained by means of the increase in pressure.
the device according to the invention therefore precisely measures the gaseous fluid flow rate on the one hand and the (neat) liquid fluid flow rate on the other hand: these flow rates are volume flow rates that can be converted into mass flow rates if the precaution has been taken of adding temperature and pressure probes and the necessary correction calculation is made (well known to gas experts).

Provided with the two corrected flow rate measurements, it is possible to make all the required calculations of two-phase rates in the liquid/gas mixture, refrigeration energy available per litre of mixture, etc.

The comparative behaviour of the devices described in the context of FIGS. 1 to 3 is explained below.

The following table shows the effect of the height of liquid on the boiling point of a cryogenic fluid (liquid nitrogen) starting from 2 bar relative.

| | Relative pressure | |
|---|---|---|
| Height of liquid of | obtained with the liquid | Boiling point |
| density 752 g/litre (mm) | height (barg) | (K) |
| 0 | 2 | 87.9 |
| 1330 | 2.1 | 88.3 |
| 2660 | 2.2 | 88.6 |
| 3990 | 2.3 | 89.0 |
| 5320 | 2.4 | 89.3 |
| 6650 | 2.5 | 89.7 |

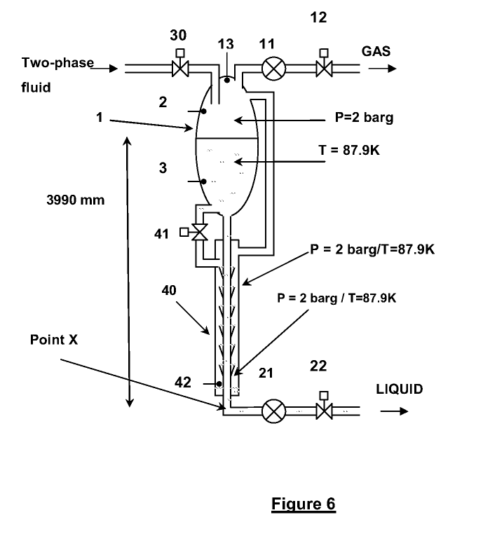

On the basis of the data in this table, the operating conditions observed for each of the embodiments in FIGS. 1 to 3 are detailed in the accompanying FIGS. 4 to 6, for which the following information can be given:
FIG. 4—at point X:
   When the fluid circulates at point X, P=2.3 barg/T=87.9 K and a low risk of boiling is obtained. The fluid is cold since it arrives in the tank at a height where the pressure and temperature conditions are P=2 barg T=87.9 K. Under these conditions, a substantial pressure drop (0.3 bar) is necessary to create the conditions of appearance of flash.
   When the fluid remains immobile and heats up, P=2.3 barg/T=89.0 K is obtained. The fluid was cold but it heats up to its boiling point at 2.3 barg: 89.0 K. Under these conditions, a very slight pressure drop is then required, when the flow resumes for example, in order to create the conditions of appearance of flash in the central tube.
   In other words, the risk of boiling is low when the fluid circulates and is very high during start-ups.
FIG. 5—at point X:
   When the fluid circulates at point X, P=2.3 barg/T=87.9 K and a low risk of boiling is obtained; here again the fluid is cold since it arrives from the tank at a height where the pressure and temperature conditions are P=2 barg T=87.9 K. Under these conditions, a significant pressure drop (0.3 bar) is necessary to create the conditions of appearance of flash.
   When the fluid remains immobile and heats up, P=2.3 barg/T=88.6 K is obtained. The fluid in the central tube was cold but it heats up to reach the temperature prevailing between the two tubes T=88.6 K. At this temperature flash appears at 2.2 barg whereas the static pressure is 2.3 barg. Flash will therefore appear in the central tube when a pressure drop greater than 0.1 bar is created, on resumption of the flow for example.
   In other words, the risk of boiling is very low when the fluid is circulating and is significant during start-ups.
FIG. 6—at point X:
   When the fluid circulates at point X, P=2.3 barg/T=87.9 K and a low risk of boiling is obtained. The fluid is cold since it arrives in the tank at a height where the pressure and temperature conditions are P=2 barg T=87.9 K. Under these conditions, a substantial pressure drop (0.3 bar) is necessary to create the conditions of appearance of flash.
   When the fluid remains immobile and heats up, P=2.3 barg/T=87.9 K is obtained. The fluid in the central tube was cold but it heats up to reach the temperature prevailing between the two tubes T=87.9 K. At this temperature flash appears at 2.0 barg whereas the static pressure is 2.3 barg. Flash will therefore appear in the central tube when a pressure drop greater than 0.3 bar is created. This drop in pressure being relatively significant, this phenomena will be rare.
   In other words, the risk of boiling is here very very low when the fluid is circulating; it is very low during start-ups.

As clearly shown by the above, the flowmeter configuration proposed by the present invention offers remarkable performance and in particular a precise measurement of the flow rate of a two-phase fluid without a pressurising device, whatever the pressure and temperature conditions thereof.

It may be thought that these remarkable performances are to be connected to the combined implementation of the following measures:
the use of a phase separator situated “at a height”;
the installation of a liquid flowmeter situated necessarily lower than the phase separator in the installation, typically between 1 and 6 metres below the phase separator, so as to create a static pressure greater than the inevitable pressure drops and thus prevent any vaporisation of the liquid passing through the liquid flowmeter;
the advantageous use according to the invention (but which must be considered merely to be an option) of a double concentric tube with optionally baffles between the phase separator and the liquid flowmeter that makes it possible to preserve the temperature of the liquid arriving at the liquid flowmeter and to prevent any vaporisation of the liquid during the phases where the flow rate is very low or zero.

And it may be thought that the charge height of the cryogenic liquid proposed by the present invention makes the liquid less sensitive to ingresses of heat and vaporisation. In some way, the liquid is sub-cooled without a pump and without injection of gas in order to effect pressurisations as in the prior art, this by a simple but incredibly effective configuration, where the liquid is subjected to gravity by means of vertical (or substantially vertical) pipework but in any event descending in space, of a sufficient height to create the pressure needed.

1-12. (canceled)

13. A flowmeter for two-phase liquid/gas cryogenic fluids, comprising:
a liquid/gas phase separator, preferentially consisting of a tank, in the top part of which the cryogenic liquid is admitted;
a liquid flow-rate sensor, situated on a liquid duct in fluid communication with the bottom part of the tank;
a gas duct, in fluid communication with the top part of the tank, provided with a gas valve;
a device for measuring the liquid level in the tank, wherein the tank is placed in a high position in space with respect to the liquid flow-rate sensor, a high position represented by the presence of a descending tube, connecting the bottom part of the tank to the liquid duct.

14. The flowmeter for two-phase liquid/gas cryogenic fluids of claim 13, further comprising: a liquid valve that is upstream or downstream of the liquid flowmeter on said liquid duct, and a sensor for the flow rate of the gas phase issuing from the top part of the tank that is situated on said gas duct upstream or downstream of said gas valve.

15. The flowmeter for two-phase liquid/gas cryogenic fluids of claim 13, wherein the descending tube is a vertical or substantially vertical tube.

16. The flowmeter for two-phase liquid/gas cryogenic fluids of claim 13, wherein it also comprises, around all or part of the length of said descending tube, a concentric tube forming between the descending tube and the concentric tube a concentric cavity able to receive liquid coming from the separator, while the evaporation gases from this cavity are able to be returned to the top part of the separator.

17. The flowmeter for two-phase liquid/gas cryogenic fluids of claim 16, wherein all or part of the height of the concentric cavity is provided with baffles.

18. The method for measuring the flow rate of a two-phase liquid/gas cryogenic fluid supplying a consuming appliance, using the flowmeter of claim 13 to measure a flow rate of a two-phase liquid gas cryogenic fluid, the flowmeter being positioned in line on a duct supplying the appliance with the cryogenic fluid.

19. The flow rate measurement method of claim 18, wherein a liquid valve is present, upstream or downstream of the liquid flowmeter on said liquid duct and in that the liquid valve is automatically closed when the liquid level in the phase separator is below a minimum low limit.

20. The flow rate measurement method of claim 19, wherein the closure of the liquid valve is effected in a non-abrupt fashion, gradually, on approaching a low level of liquid in the tank approaching said low limit.

21. The flow rate measurement method of claim 20, wherein, during the closure of the liquid valve, the gas valve remains open.

22. The flow rate measurement method of claim 18, wherein a sensor for the flow rate of the gas phase issuing from the top part of the tank is present on said gas duct upstream and downstream of said gas valve, and in that the gas valve is automatically closed when the liquid level in the phase separator is above a high limit.

23. The flow rate measurement method of claim 22, wherein the closure of the gas valve is effected in a non-abrupt fashion, gradually, on approaching a high level of liquid in the tank approaching said high limit.

24. The flow rate measurement method of claim 23, wherein, during the closure of the gas valve, the liquid valve remains open.

25. The flow rate measurement method of claim 13, wherein the device for measuring the liquid level in the tank comprises a lower level sensor and an upper level sensor.
